(19) United States
(12) Patent Application Publication
(10) Pub. No.: US 2006/0265311 A1
(43) Pub. Date: Nov. 23, 2006

(54) Threshold trading method

(75) Inventors: David Dean, Provo, UT (US); William Alan Furniss, Pleasant Grove, UT (US); Shawn Thomas Lucas, Pleasant Grove, UT (US); Fred Dowie Vander Werff JR., Oren, UT (US)

Correspondence Address: AKERMAN SENTERFITT, P.O. BOX 3188, WEST PALM BEACH, FL, 33402-3188, US

(73) Assignee: Whitney Education Group, Cape Coral, FL (US)

(21) Appl. No.: 11/134,151

(22) Filed: May 20, 2005

(51) Int. Cl. G06Q 40/00

(52) U.S. Cl. 705/37

(57) ABSTRACT

The method of investing in the stock market using the Threshold Trading Method wherein multiple stock movement trends are studied and the investor's decision to purchase stock is based primarily on the direction of the next longer trend.

### BACKGROUND OF THE INVENTION

Investors in the stock market are faced with many challenges such as whether to invest in single stocks vs. mutual funds, stock indexes or other investment vehicles. Many areas of investment are getting more sophisticated as new opportunities become available. The individual investor is challenged with investing on his own or with using a full service brokerage house and following the advice of brokers and analysts. If it is presumed that the investor will trade individual stocks then it becomes necessary to have a means of identifying stocks that are good candidates for investments. Choices between small caps vs. large caps, the choices of stocks on different exchanges, and sector performance become the type of challenging issues to the investor.

There is considerable literature which has accumulated on different plans and investors are uniformly encouraged by professionals to develop a sound system of investing as opposed to a random emotional approach which can often be disastrous for the individual investor.

Even once past initial stock selection, there are also many challenges for the investor associated with what is generally known as technical analysis, the discipline of forecasting future price based on the study of current market action. Technical analysis typically will consider all current economic, fundamental, psychological, political, and any further prevailing market influences.

The subject invention relates to a method of technical analysis wherein the investor, by following certain market rules, can eliminate many of the types of pitfalls which have plagued investors for years. The analysis finds its origins in the fundamental operation of the markets as supported by a strong influence factor of market history which leads to expected market activity.

### SUMMARY OF THE INVENTION

The subject invention which will be identified as the Threshold Trading Method™ provides a method of technical analysis which is primarily based on entry and exit techniques to give the investor a plan to purchase and sell stocks at key times in a market cycle.

The method avoids investments in stock that are unlikely to advance in value or even decrease in value. It also provides the wherewithal to the investor to know when to exit the market i.e., sell stock close to the optimum time when it becomes unlikely that continued appreciation in the stock value will occur.

The Threshold Trading Method is based on an understanding of the three types of market trends as the supporting theory is based in part on the fact that stock price moves in trends.

Understanding this trending phenomena gives investors the opportunity to seek patterns of activity in stocks that will lead the investor to various conclusions supported by the likelihood of future action based on the trending phenomena.

The Threshold Trading Method is based in part on the recognition that there are three major timeframes of trends i.e. a primary trend, an intermediate trend, and a short-term trend. Immediate trends are made up of shorter term trends and the primary trend is typically formed by a series of intermediate trends.

The Threshold Trading Method also depends on tools to be used with trendline studies such as moving averages. Trendlines and moving averages are typically based on stocks moving in a series of peaks and valleys. Under the Threshold Trading Method, peaks and valleys typically indicate levels of reversal in the market. Valleys are called support levels and peaks are called resistance levels.

A support level comes at the end of a sell-off or a decline and is commonly recognized as the price level or zone where demand for a stock overwhelms supply.

On the other hand resistance comes at the end of a rally or rising price and is generally defined as the price level or zone where the supply for a stock overwhelms the demand.

Thus, under the Threshold Trading Method as a market is trending higher the trendline or moving average becomes a support zone. As the market is trending lower, the moving average or trendline becomes a resistance zone.

The threshold under the Threshold Trading Method can be considered either an entry or exit position. The Threshold Trading Method identifies a certain threshold, associated with identifying the trend that the investor wishes to trade in so that he can then be prepared to trade in the direction of the next longer trend.

The Threshold Trading Method calls for the identity of three support zones and further the identity of three resistance zones in the preferred embodiment of the invention.

Typically under the Threshold Trading Method if the next longer trend is upward and if the stock moves upwardly off of the support zone, the investor would invest in the stock from a technical analysis standpoint. If the stock trades down through the support zone, the investor would apply various filter rules to determine whether to purchase the stock. Generally, three common filtering techniques in trading are price, time and volume filters and additionally, combinations of the three which enable the investor to distinguish between breakouts and fakeouts before investing.

### BRIEF DESCRIPTION OF THE DRAWINGS

FIG. 1 is a stock chart which shows the first stage of the four stages of trend development;

FIG. 2 is a stock chart which shows the second stage of trend development, namely, after a breakout has occurred;

FIG. 3 is a stock chart which shows stages three and four of trend development, namely, stage 3, when the market moves to a buying peak followed by a market retreat on high volume which leads to stage 4, when the market begins to test key support levels;

FIG. 4 is a stock chart that shows short, intermediate and primary trend lines;

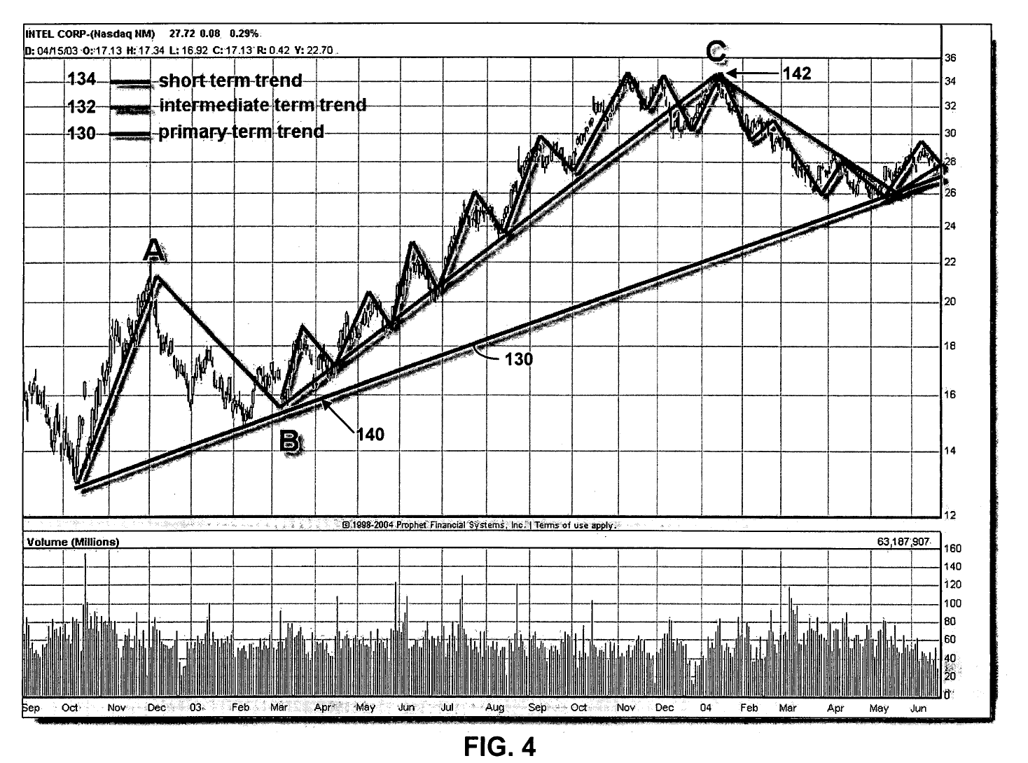

FIG. 5 is a stock chart which shows an uptrend line and its relationship to market valleys;

FIG. 6 is a stock chart which shows a downtrend line and its relationship to market peaks;

FIG. 7 is a stock chart which shows the need to redraw trend lines;

FIG. 8 is a stock chart which demonstrates the use of a moving average;

FIG. 9 is a stock chart which demonstrates a support level;

FIG. 10 is a stock chart which demonstrates a resistance level;

FIG. 11 is a stock chart that shows examples of support and resistance relationships to the moving average and;

FIG. 12 is a stock chart that shows the necessary components for applying the Threshold Trading Method.

### DETAILED DESCRIPTION

As will now be discussed in detail, it is important for the investor to develop a trading plan that outlines a specific approach to investing. Once a resource pool of stocks is developed that provides candidates for investment, some method of analysis is necessary to help manage the stocks that are on a watch list and which then become part of an investment portfolio.

The method of the present invention which is known as The Threshold Trading Method™ provides a method of technical analysis based on entry and exit techniques to provide the investor with an analytic approach to the management of stocks.

Technical analysis as used herein, is the discipline of forecasting future price based on the study of current market action. One basic tenet of this technical analysis is the efficient market theory: “Everything known about a company is reflected in the current market price”. Technical analysis considers all current economic, fundamental, psychological, political, and any other prevailing market influences.

Technical analysis as it is presented under the method of the present invention also holds to the theory that price moves in trends. People derive signals from the action of someone else. If a famous investor called 100 people on the phone and told them that he was buying XYZ Company stock, a good percentage of those people would take that as a signal they should buy XYZ as well. At this point, these people would enter the market. This is the start of a buying trend.

A premise that supports the present invention is that certain patterns and trends will develop time and time again. Market history does repeat itself. If an investor can recognize historically documented patterns early, he can profit from the expected movement. A dictionary definition of the word trend is “the general direction in which something tends to move; a general tendency or inclination”.

Trends are common in many environments. Meteorologist measure trends in weather. Economists measure trends in the economy. City planners measure trends in population growth. Fashion designers measure trends in fashion. Market trends which form the underpinning for the present invention can be broken down into four separate stages of development.

The first stage is trend development. As a trend begins, there is very little direction in the market. The market is classified as flat or sideways. Stage I is highly speculative and few traders participate during this phase of the trend. Investors assume high levels of risk in hopes of large gains. At this stage the market is normally oscillating within a range of support and resistance.

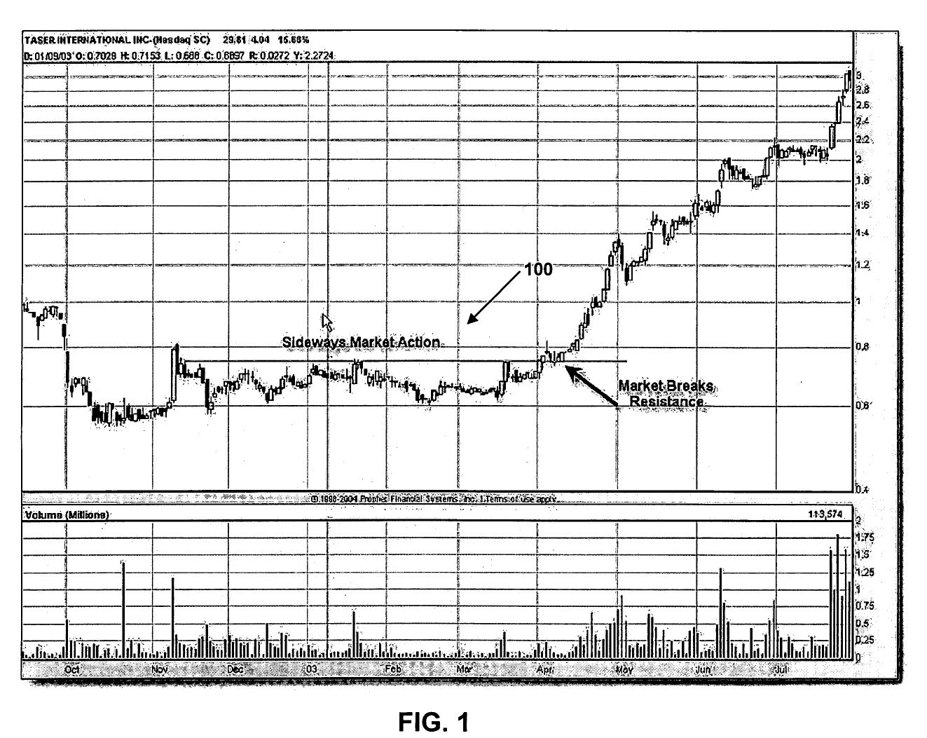

The beginning stage will end with a breakout of the trading range. A breakout can be fast or slow, depending on the amount of popular interest in the stock; it is usually associated with an increase of volume. Breakout and increased volume are early indications that a trend is about to begin. With reference to FIG. 1, a typical stock graph is shown with the vertical axis showing stock values and the horizontal axis, time as noted in months. Accompanying such graph as is typical is a volume of trade section at the base with volume represented on the vertical axis. Note the sideways market action as indicated by the horizontal line 100 on the chart. Taser (the stock measured here) broke the resistance level and began a new trend in early April as the stock price climbed over the next four months. The volume increases can be seen at the time of the breakout.

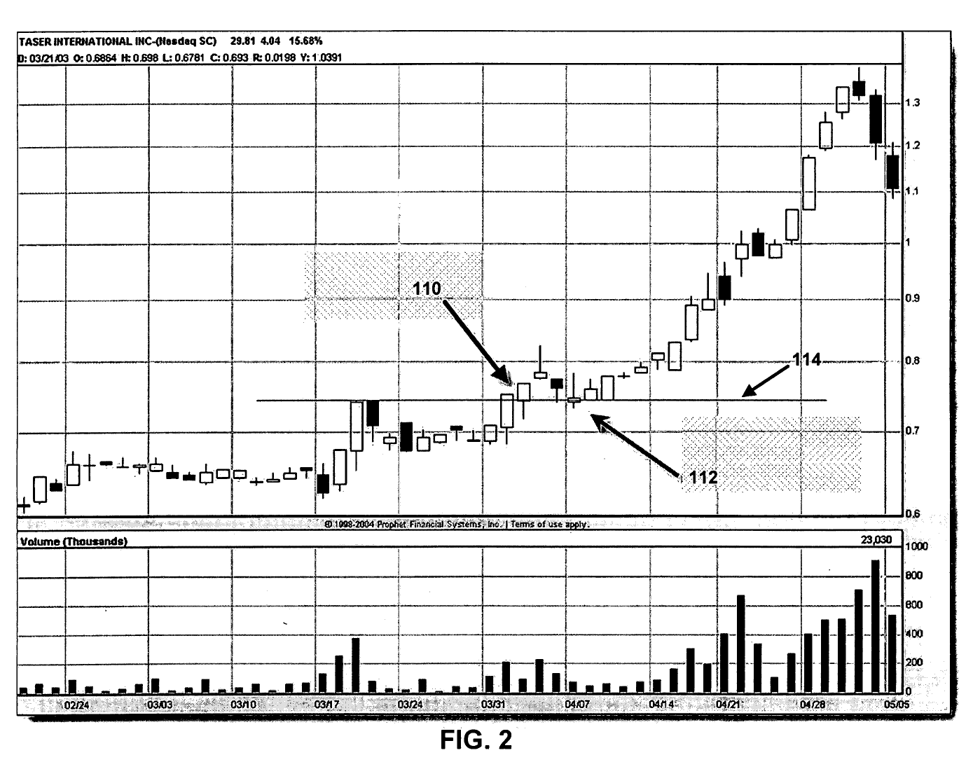

Stage II begins after the breakout has occurred. The beginning of stage II is shroud with uncertainty. However, more traders enter the market with the hopes of participating in the trend. Many traders look for the market to return to the breakout point before they enter the market. However, depending on the force of the breakout, the market may or may not come back to the breakout point. In stage II, you would look for the market to begin developing a trend of successive supports. You would also expect the market to increase in volume as the trend gains more support. With reference to FIG. 2 the market breaks the trading range 110 and then retreats back to the breakout point 112. The breakout point becomes an important support level shown by line 114 that should not be violated by future price movement in order for the stock to remain a buy candidate.

Stage III is where the masses join in the trend. One may notice a spike in price or volume as the investing public enters the trend. The psychology behind this stage of a trend indicates that everyone who wants to participate in the market does so now, when the trend is well established. After stage III, there maybe very little money left sitting on the sidelines. Most interested investors have already joined the trend.

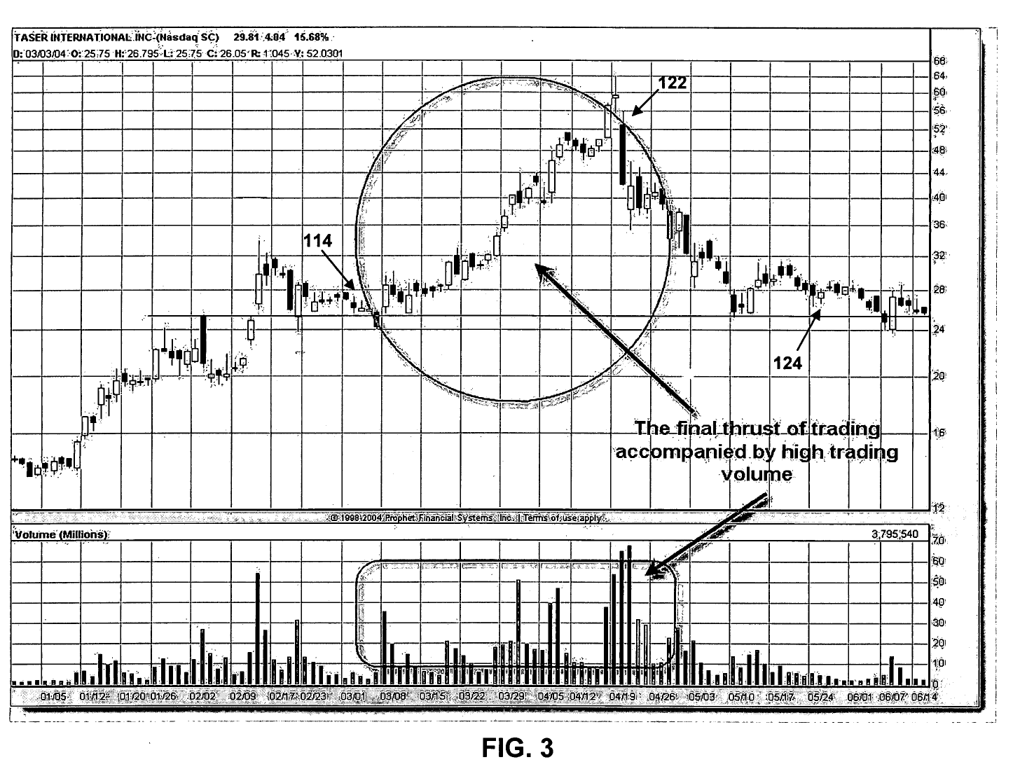

As shown in FIG. 3, the market explodes off the support line from point 120 toward a buying peak 122. The market then retreats on high volume back toward the support line.

Stage IV marks the final stage of a trend. As noted above, there is very little money left to continue the trend's progress. The trend begins to test key support areas. The market fails to break previous resistance levels and begins to move sideways.

This sideways movement tells us that we ought to proceed with caution, as a new opposing trend may be looming. It is difficult to know where the market will go after Stage IV. The market can maintain its sideways action, resume its uptrend, or begin a downtrend. As shown also in FIG. 3, the market begins to test key support levels at point 124. This should be a warning that a future trend change could be looming which may be a downward trend next time.

Many would advocate that the first thing an investor should do before he enters a trade is determine which stage of the trend the stock is in. If in Stage II of an uptrend, then an investor would not want to be selling his stock. On the other hand, if in Stage IV of an uptrend an investor would not want to be buying stock.

By identifying the different stages of the market, an investor can make better decisions on when to enter or exit the stock. Such fundamentals are widely recognized and form a background for the subject invention.

Another basic tenet of trend analysis is: “A trend in motion stays in motion until an equal or opposite force acts upon it”. The driving force of any market trend is basic supply and demand. If demand exceeds supply, stock price will go up. If supply exceeds demand, price will go down. You know that in an upward trend, price will continue to rise until it reaches a price where no one wants to buy it. At this point supply exceeds demand and prices begin to fall.

Trends are classified into three major timeframes:

1. Primary Trend

2. Intermediate Trend

3. Short-term Trend

Primary trends last from nine months to two years. Primary trends are usually based on the fundamentals of the economy.

Intermediate trends last from six weeks to nine months. Intermediate trends are considered market corrections, where the market responds to problems of over-supply or over-demand. An event that might precipitate a change in the intermediate trend could be an earnings announcement or a management change.

Short-term trends last from two to four weeks. Short-term trends are usually based on random news events, such as an analyst upgrading or downgrading the stock.

It is also important to note that longer-term trends are made up of shorter-term trends. The primary trend is formed by a series of intermediate trends. The intermediate trend is formed by a series of short-term trends. One of the first steps in trend analysis particularly under the method of the present invention is to identify which trend the investor is looking at, and how the current trend relates to trends of other timeframes.

In accordance with the method of the present invention, when an investor is trading stock, he should always trade in the direction of the next larger trend.

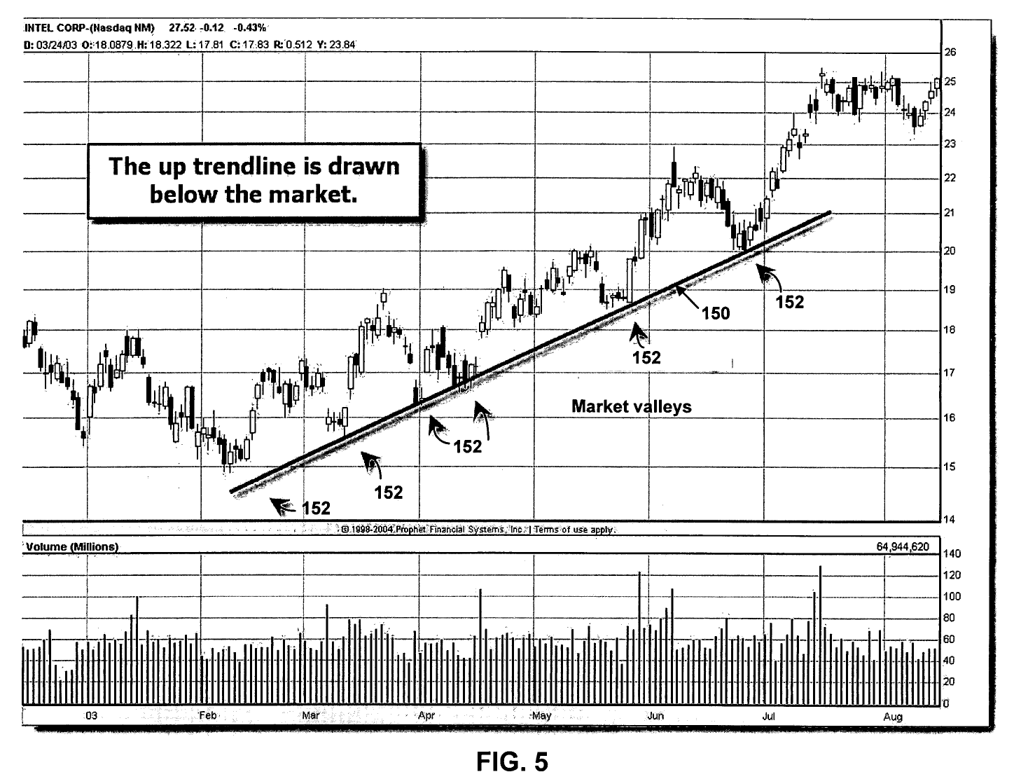

The logic behind this idea can be appreciated from looking at FIG. 5. The primary trend is shown as line 130. Intermediate trend is shown by line 132. Short term trend is shown as line 134. The primary trend 130 is up; this means that you should be bullish on the stock, so you can look for a favorable entry point to purchase on the intermediate-term trend 132. If you bought at point 140 and exited the trade at point 142, you would have made approximately $16. Your piece of the pie is largest when you trade in the direction of the next longer trend.

Point 140 is an excellent entry point. The primary trend is up. Point 140 is the bottom of the intermediate trend 132, and the bottom of the short-term trend 134. Point 140 is the triple crown of trading because all three trend lines are merging, while the primary trend 130 is up; all signals point to buy.

The market can take any of three directions; up, down, or sideways.

A simple way to determine the direction of a trend is to look at the peaks and valleys of the market. An uptrend shows higher and higher peaks, along with and higher and higher valleys. A downtrend is defined by lower and lower valleys, along with and lower and lower peaks. A trendless market has peaks and valleys that are not moving any higher or lower.

Trend direction gives us a first tool in technical analysis: the trendline. A trendline is a graphical representation of a current trend. While there is no “right” way to draw a trendline, because it is a person's interpretation of the market, some guidelines are a help to begin drawing trendlines.

An up trendline must have a positive slope. It will be formed by connecting two or more valleys, where the second valley is higher than the first. The up trendline acts as support and indicates that demand and price are increasing. A rising price combined with increasing demand is considered bullish; it shows a strong buying conviction on the part of buyers. As long as price remains above the trendline, the uptrend is considered solid and intact. A break below the up trendline indicates that demand has weakened and a change in trend could be imminent. With reference to FIG. 5, the up trendline 150 is beneath the market measurements, with each successive valley 152 in line with the previous one.

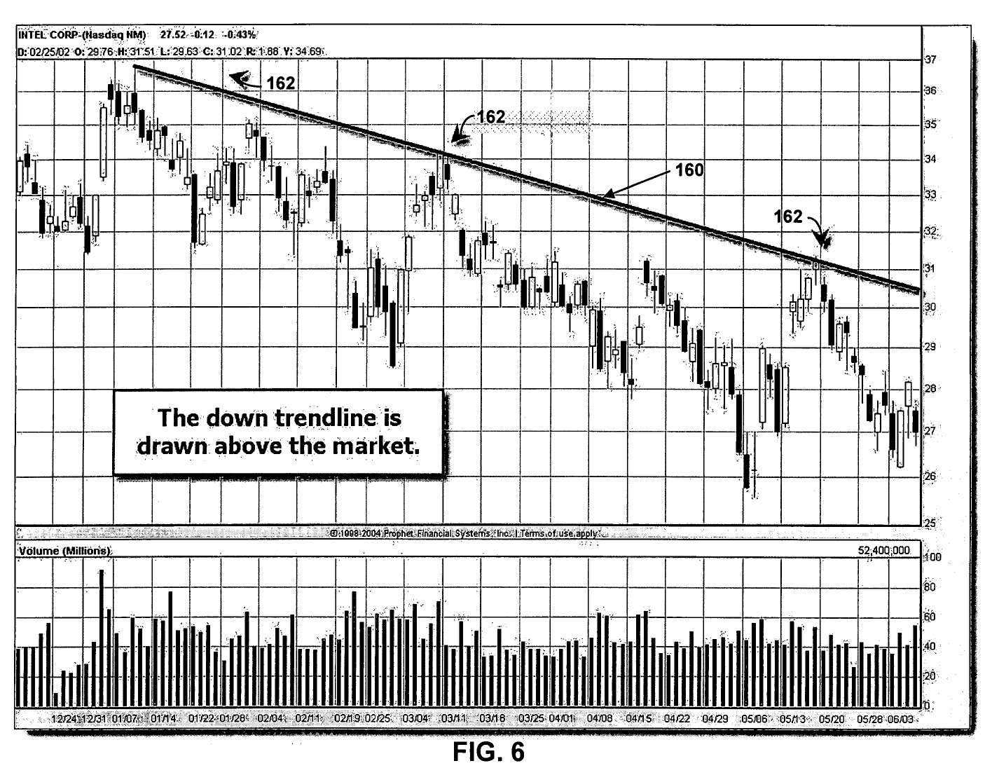

A down trendline as in FIG. 6 has negative slope 160. This line 160 will be formed by connecting two or more peaks 162, where the second peak is lower than the first. Down trendlines act as resistance and indicate that supply is increasing even as the price declines. A declining price combined with increasing supply is bearish; it indicates strong resolve on the part of sellers. As long as price remains below the down trendline, the downtrend is considered solid and intact. A break above the down trendline indicates that supply and demand are balancing out and a change of trend could be imminent.

Two or more points are needed to form a trendline 150, 160. The more points one uses to draw the trendline 150, 160, the stronger the support or resistance level represented by the trendline 150, 160 will be. Sometimes it can be difficult to find more than two points from which to construct a trendline 150, 160; sometimes the lows or highs just don't match up. In this case, it's best not to force the issue. The general rule of technical analysis is that it takes two points to draw a trendline 150, 160, with a third point to confirm the trend.

The valleys 152 used to form an up trendline 150 and the peaks 162 used to form a down trendline 160 should not be too far apart, or too close together. A well balanced cycle of price movement that is “just right” is desired. The most suitable distances will depend on the timeframe, the degree of price movement, and personal preferences. If the valleys 152 are too close together, the validity of future valleys may come into question. If the valleys 152 are too far apart, the relationship to the next valley could be suspect. An ideal trendline is made up of relatively evenly spaced peaks and valleys.

In addition to the spacing of peaks and valleys, it is important to consider the angle of the trendline. A steeper trendline is hard to sustain, traders do not like the stock to go straight up. The validity of the support or resistance level decreases the steeper the trendline becomes. A steep trendline results from a sharp advance (or decline) over a short period of time. Even if the trendline is formed with three seemingly valid points, attempting to play a trendline support will often prove difficult. As a general rule, a trendline above 45 degrees is speculative and generally unsustainable.

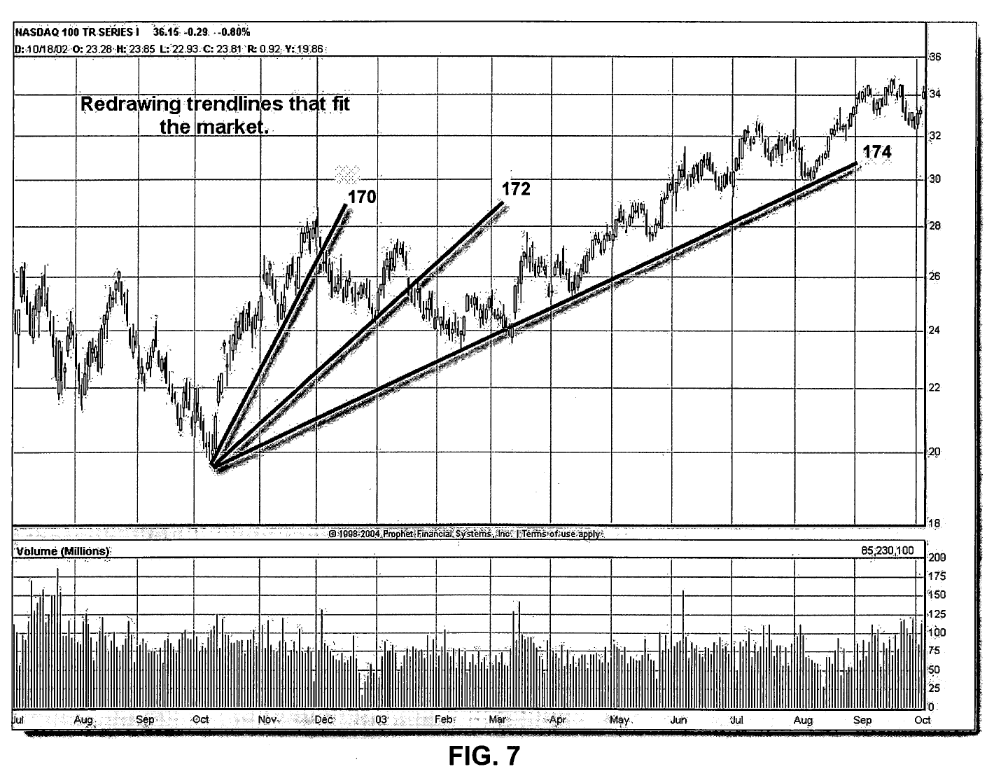

Trendlines are drawn to accommodate a strengthening or weakening market. With reference to FIG. 7, note that the market's initial surge formed a nice, clear trendline (170). However, the slope 170 is too sharp; the market is not able to sustain the pattern. As the market corrects back to a more sustainable trend, the trendline is redrawn (172). This new trendline is still too steep for the market to sustain. The final trendline (174) is comfortable to the market, and the trend continues for several months.

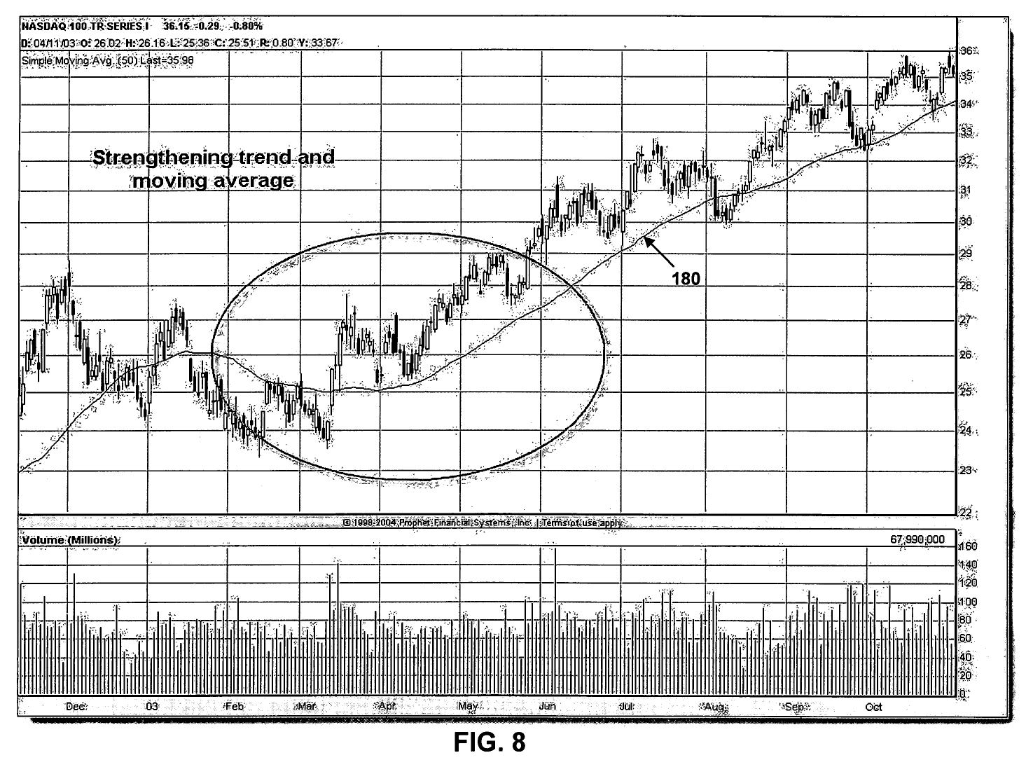

Other tools used to identify strengthening and weakening trends are moving averages. Moving averages are shown as curvilinear shapes 180 (meaning they will not be drawn as straight lines) see FIG. 8. As the trendline strengthens, the moving average 180 will curve up. As the trendline weakens, the moving average 180 will curve down. A moving average is a quick and easy way to view the current trend of the market.

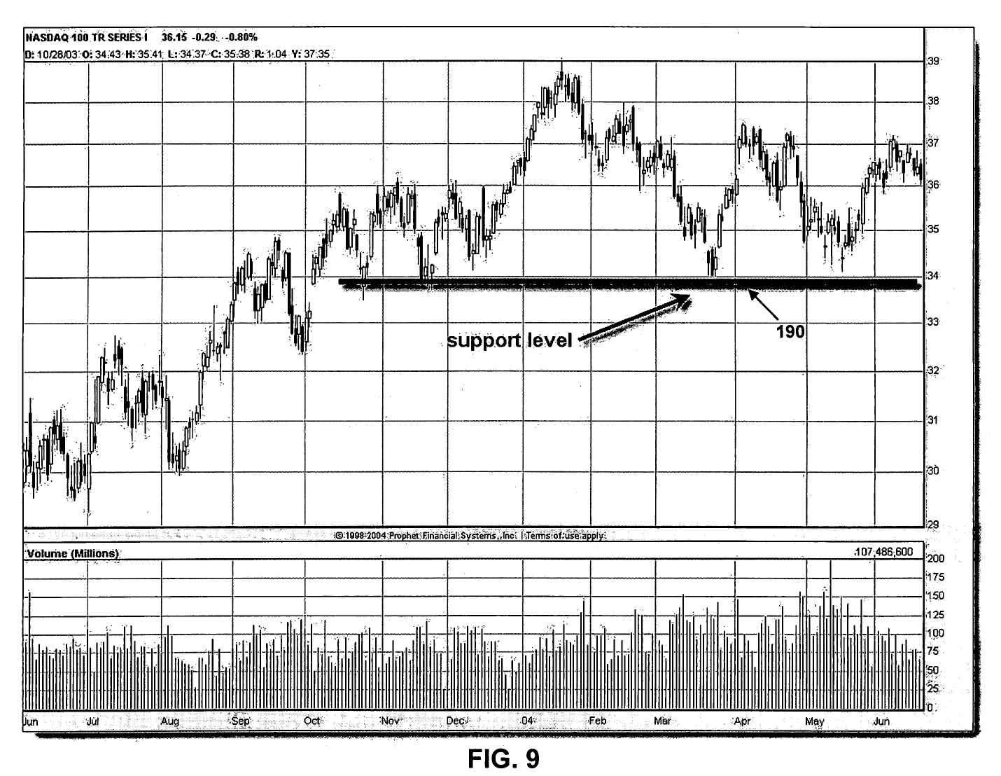

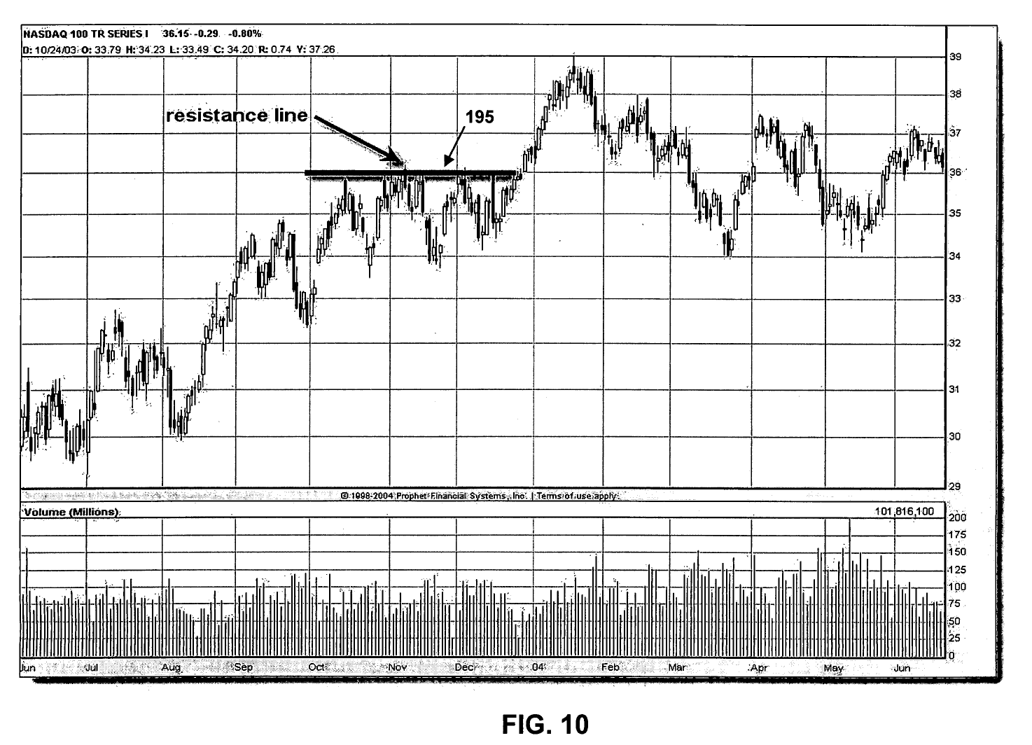

As already discussed, trends move in a series of peaks 162 and valleys 152. It is the nature of those peaks and valleys that define the trend of the market. Peaks and valleys also indicate levels of reversal in the market. Valleys are called support levels; see FIG. 9. Peaks are called resistance levels; see FIG. 10.

With further reference to FIG. 9, support comes at the end of a sell-off or decline; it is commonly defined as the price level 190 or zone where demand for a stock overwhelms supply. This change in supply and demand stops the decline and pushes the price higher. Logic states that as price declines towards support and gets cheaper, buyers become more inclined to buy and sellers become less inclined to sell. The more the market hits this zone and moves higher, the stronger the support 190 becomes. A support 190 is also called floor.

As shown in FIG. 10, resistance comes at the end of a rally or rising price; it is defined as the price level 195 or zone where the supply for a stock overwhelms the demand. This stops the current advance in price. Logic states that as price rises towards resistance and becomes more expensive, sellers are more inclined to sell and buyers are less inclined to buy. The more the market hits this zone and moves back down the stronger the resistance level 195 becomes. A resistance 195 is also called a ceiling.

Traders consult support 190 and resistance 195 zones for an idea of where markets will change direction. For example, if you have had a previous peak at 162, then you would look at that price level to mark a zone where the markets might turn around in the future. Likewise, if you had previous valley 152, you would look at that price level to give you support in the future.

An upward trend must have higher and higher highs, and higher and higher lows. A downward trend, of course, is identified by lower and lower highs with lower and lower lows.

Support and resistance are like floors and ceilings of a multiple-story building; they reverse roles as you climb up and down the stairs. If you start out on ground floor and climb the stairs, your old ceiling becomes your new floor. Similarly, as you rally through a previous peak, or benchmark high (your ceiling), then you look for that point to become your new support (your floor). As stated: “Old resistance becomes new support; old support becomes new resistance”.

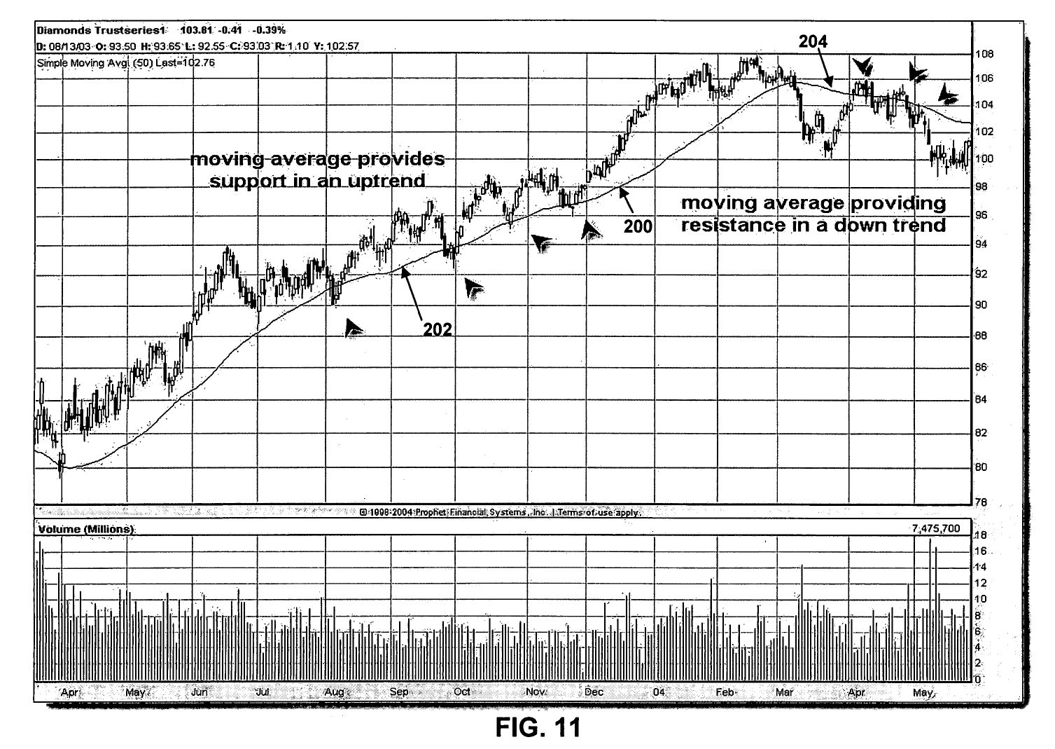

As shown in FIG. 11, as a market is trending higher, you can use the moving average 200 as a support zone 202. Likewise, as a market is trending lower you can use the moving average 200 as a resistance zone 204.

The roles of support and resistance reverse as the market breaks the moving average 200. In an upward-trending market, the moving average provides good support and buying opportunities. As the market breaks down through the moving average, the moving average reverses roles and becomes resistance. The opposite is true as well—as the downward-trending stock breaks up through the moving average, the resistance reverses roles and becomes support.

It can be hard to know whether the market is actually breaking a support or resistance, or whether it is bouncing off it like a trampoline. The markets are not always clear cut, but there are some guidelines for filtering out bad signals. Keep in mind that support 202 and resistance 204 levels are action zones. If you identify a support zone 202, you will be looking to take action, or buy, anywhere in that zone.

Filtering is a method used to determine whether a market is breaking or holding a support or resistance level. When a market is breaking a support or a resistance level, it is called a breakout. Sometimes the market may appear to be breaking the support or resistance level, but then quickly reverses; this is called a fakeout. While there is no way to know in advance whether the support or resistance levels are going to hold or break, filtering techniques can be applied to help manage investments.

Filters help eliminate whipsaw trades. There are three common filtering techniques used in trading: price, time and volume.

Price filters are what most people use to identify a support or resistance break. Ideally, you would look for a close above or below the support or resistance zone before you took any action. This will filter any intraday penetration of the zone. Another common price filter is to wait for a close and a 1-3% penetration of the support or resistance zone. If the price is able to establish a level of comfort over the resistance zone or under the support zone, then there is a greater likelihood that the breakout is valid. A 1% price filter will generate more fakeouts than a 3% price filter.

Time is another tool used to filter breakouts. As a general rule, a time filter of one to three days is best. If the market closes beyond the support or resistance zone for 1-3 days, then there is a good chance that the breakout is valid. The shorter the timeframe is, the more likely a fakeout. With a longer time filter, you give up more upside potential.

Volume is an excellent breakout filter. As a stock is approaching a support or resistance zone, volume tells us how many people are interested in pushing price through the zone.

Another common technique is to use a combination filter, using more than one type of filtering method. For example, we could decide that we need a 2% price penetration with 150% volume increase through a support or resistance zone before action is taken.

Using the concepts of trends, support and resistance, and breakouts the method of the present invention, the Threshold Trading Method™, is formulated which is a systematic approach to identifying entry and exit points. A threshold is a point of action; it is the point that must be reached to begin producing a given effect. In other words, it is the limit that must be reached before another move is made.

The threshold can be either an entry or an exit. An entrance threshold is established to enter the market at a given price. Once the threshold is established, one waits for the markets to trade until it reaches that point, and then the trade is entered. Meanwhile, an exit threshold is established. Again, one waits for the market to reach a target price, and when the markets trade to that level, the trader exits his trade.

There are three basic rules to follow to identify thresholds, under the present invention:

1. Identify the trend of the investor's choice: long, intermediate or short. Trade in the direction of the next longer trend.

2. Identify three support zones (if possible) below the current price of the market.

3. Identify three resistance zones (if possible) above the current price of the market.

RULE #1: Trade in the direction of the next longer trend. This rule is applicable to any level of trading, whether short-term or long-term. The key to success is being able to correctly identify both the trend the investor wishes to trade, and the next longer trend. If the investor trades in the direction of the next longer trend, he will always be on the right side of the market. The investor should never trade against the trend.

RULE #2: Identify three zones of support. Support lines will become an entrance threshold. If the support level is broken, it will likely reverse sales and now become a resistance level; the market will likely trade down to your next support level. There are two exit thresholds: the price target, and stop loss. Use a resistance zone for your price target and a support zone for your stop loss.

RULE #3: Identify three zones of resistance. The investor uses resistance lines to become the exit threshold. There are two exit thresholds: the price target, and stop loss. A resistance zone is used for a price target and a support zone for a stop loss.

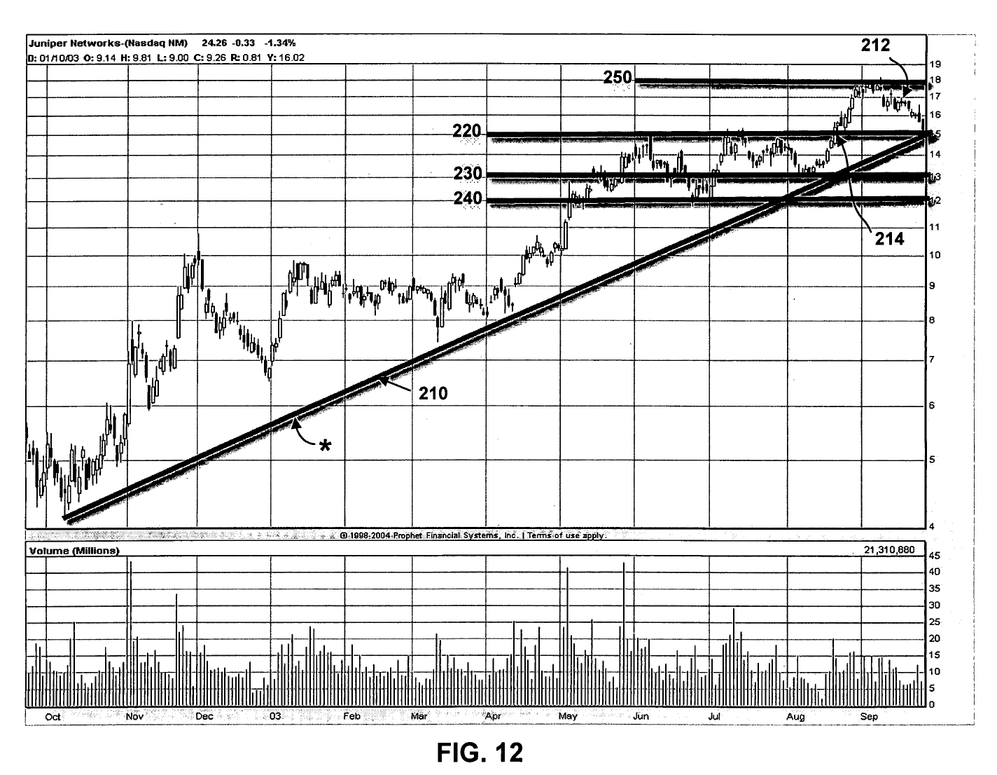

FIG. 12 illustrates the Threshold Trading Method™ of investing. First, the prevailing trend as represented by the trendline 210. The short-term trend 212 is currently down, but as per Rule #1, the next longer trend 214 is up—so we would be buyers of this stock. Rule #2 tells you to identify your entrance thresholds and three zones of support. The entrance threshold would be zone 220; the three zones of support are represented by lines 220, 230, 240. Rule #3 tells you to identify your exit threshold and identify (if possible) three zones of resistance. In this case, only one zone of resistance is identified at point 250.

Should the stock in FIG. 13 bounce off support zone 220, under the Threshold Trading Method, one would pick up shares of this company. If the stock trades down through support zone 220, under the Threshold Trading Method, the investor should apply filter rules before purchasing the stock.

Under the Threshold Trading Method, the investor has identified a trend. He has drawn three support and resistance lines and identified the entrance threshold. Now the question becomes, “When does he actually place his order?” The investor does not know if your stock will actually reverse or break the support level. The first defense is to be vigilant with filtering rules if the stock trades lower than the support line. The second defense is to know what a reversal looks like.

To spot reversals, traders use the trading range, a well known concept. The trading range is the difference between the high and the low. On a candlestick chart, it would be the difference between the top of the candle and the bottom of the candle. As the stock is moving down toward a support level, the lows are getting lower and the highs are getting lower.

At this point, a useful adage of traders can be applied: “Never buy on the way down”. Wait until your stock has established “a higher high before you buy”. The opposite is true as well, “Never sell on the way up”. Wait for a “lower low before you go”.

Thus under the Threshold Trading Method, the following general well known buying and selling guidelines are helpful.

1. Buy when the stock reaches your entrance threshold and trades above the prior days high.

2. Sell when the stock reaches your exit threshold and trades below the prior days low.

The investor may want to place stops below support zones to automatically sell stock. The trick to using a stop effectively is to know how far below the support zone to place your stop. If you place it too far below the support zone you stand to have bigger losses. If you place the stop too close to the support zone you may get whipsawed out of the trade. Many traders use their price filtering rules to set their stop 1-3% below the support zone.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

The invention can be embodied in other forms without departing from the spirit or essential attributes thereof. Accordingly, reference should be made to the following claims, rather than to the foregoing specification, as indicating the scope of the invention.

What is claimed is:

1. A method of investing in the stock market utilizing at least two trends comprising the steps of:
identifying a first trend based upon a stock's recent past activity;
identifying the next longer trend; and
executing a trade that follows the next longer trend.

2. The method of claim 1 further including the steps of:
identifying a support zone;
identifying a resistance zone; and
using the resistance zone as a price target and the support zone as a stop loss when executing the trade following the next longer trend.

3. The method of claim 2 wherein the support zone is based upon three levels of support.

4. The method of claim 2 wherein the resistance zone is based upon three levels of resistance.

5. The method of claim 1 further including the step of applying filter rules before executing a trade.

6. The method of claim 5 wherein the filter rules include price filters.

7. The method of claim 5 wherein the filter rules include volume filters.

8. The method of claim 5 wherein the filter rules include time filters.

9. The method of claim 5 wherein the filter rules include some combination of price, volume and time filters.

10. The method of claim 1 wherein said first trend is recognized by the establishment of at least tow points of support or resistance.

11. The method of claim 1 wherein said next longer trend is recognized by the establishment of at least two points of support or resistance.

12. The method of claim 1 wherein the at least two trends are based on trendlines and a further step is:
considering the angle of trendline for the next longer trend as a factor in whether to buy stock.

13. The method of claim 12 wherein a trendline fore the next longer trend that is greater than 45° will be a negative factor as to whether to purchase stock.
